(19) United States
(12) Patent Application Publication
(10) Pub. No.: US 2020/0330304 A1
(43) Pub. Date: Oct. 22, 2020

(54) MEDICAL SUPPORTING FIXING DEVICE

(71) Applicant: ENGINEERING SYSTEM CO., LTD., Nagano (JP)

(72) Inventor: Osamu SAJIKI, Matsumoto-shi, Nagano (JP)

(73) Assignee: ENGINEERING SYSTEM CO., LTD., Nagano (JP)

(21) Appl. No.: 16/643,066

(22) PCT Filed: Aug. 22, 2018
(86) PCT No.: PCT/JP2018/030898

§ 371 Date: Feb. 28, 2020

(30) Foreign Application Priority Data
Aug. 29, 2017 (JP) 2017-164424

(51) Int. Cl. A61G 7/065; F16M 11/12; F16M 11/18

(52) U.S. Cl. CPC A61G 7/065; F16M 11/18; F16M 11/126

(57) ABSTRACT

A medical supporting fixing device having a yaw angle fine adjustment plate (6) and/or a tilt angle fine adjustment plate (8) interposed between a stage (2) and a supporting fixing means (4) for supporting and fixing a predetermined part of a human body. The yaw angle fine adjustment plate (6) and/or the tilt angle fine adjustment plate (8) are mounted so as to be rotatable over a predetermined angular range about required rotation center axes (22, 48). A yaw angle fine adjustment plate drive mechanism (16) and/or a tilt angle fine adjustment plate drive mechanism (54) including input members (28, 72) and transmission means (36, 38, 42, 74, 80, 82, 84, 86) are disposed with respect to the yaw angle fine adjustment plate (6) and/or the tilt angle fine adjustment plate (8).

### TECHNICAL FIELD

This invention relates to a medical supporting fixing device including a supporting fixing means for supporting and fixing a predetermined part of a human body, for example, the head. More specifically, the invention relates to a medical supporting fixing device capable of finely adjusting the yaw angle and/or the tilt, angle of a supporting fixing means for supporting and fixing a predetermined part of a human body.

### BACKGROUND ART

In performing radiotherapy involving irradiation of a predetermined part of a human body with radiation; or diagnostic imaging, such as CT or MRI, for acquiring an image of a predetermined part of a human body for the purpose of diagnosis, it is important to support and fix the predetermined part while positioning it at a required position with sufficient precision. Patent Document 1 indicated below discloses a medical supporting fixing device for use in radiotherapy, the device capable of adjusting the yaw angle and tilt angle of a head supporting fixing means for supporting and fixing the head of a human body.

### PRIOR ART DOCUMENTS

### Patent Documents

Patent Document 1: JP-A-Hei-6-7663

### SUMMARY OF THE INVENTION

### Problems to be Solved by the Invention

As described above, Patent Document 1 discloses a medical supporting fixing device capable of adjusting the yaw angle and tilt angle of a supporting fixing means for supporting and fixing the head of a human body. Patent Document 1 describes that of a plurality of constituent members, a specific constituent member has a yaw angle adjustable, whereas another constituent member has a tilt angle adjustable. However, this document does not disclose at all the concrete features of a means or mechanism for adjusting the yaw angle, or the concrete features of a means or mechanism for adjusting the tilt angle. Thus, this document does not have a sufficient disclosure for embodying the medical supporting fixing device capable of adjusting the yaw angle and/or the tilt angle.

The present invention has been accomplished in the light of the above facts. Its main technical challenge is to provide a medical supporting fixing device which is provided with concrete features enabling a yaw angle and/or a tilt angle to be finely adjusted, and which can therefore be embodied as a medical supporting fixing device capable of finely adjusting the yaw angle and/or the tilt angle.

### Means for Solving the Problems

As a result of in-depth investigations, the present inventor has found that the above main technical challenge can be solved by interposing a yaw angle fine adjustment plate and/or a tilt angle fine adjustment plate between a stage and a supporting fixing means for supporting and fixing a predetermined part of a human body; mounting the yaw angle fine adjustment plate and/or the tilt angle fine adjustment plate so as to be rotatable over a predetermined angular range about required rotation center axes; and disposing a yaw angle fine adjustment plate drive mechanism and/or a tilt angle fine adjustment plate drive mechanism, including input members and transmission means, with respect to the yaw angle fine adjustment plate and/or the tilt angle fine adjustment plate.

That is, according to an aspect of the present invention, there is provided, as a medical supporting fixing device for solving the aforementioned main technical challenge, a medical supporting fixing device comprising:

a stage;

supporting fixing means for supporting and fixing a predetermined part of a human body;

a yaw angle fine adjustment plate interposed between the stage and the supporting fixing means and mounted so as to be pivotable over a predetermined angular range about a pivot center axis extending perpendicularly to the stage; and

a yaw angle fine adjustment plate drive mechanism including an input member for yaw angle fine adjustment disposed movably, and transmission means for yaw angle fine adjustment interposed between the input member for yaw angle fine adjustment and the yaw angle fine adjustment plate,

wherein when the input member for yaw angle fine adjustment is moved, the movement of the input member for yaw angle fine adjustment is transmitted to the yaw angle fine adjustment plate via the transmission means for yaw angle fine adjustment, whereby the yaw angle fine adjustment plate is pivoted about the pivot center axis.

Preferably, at least two arcuate slots are formed in the stage; the arcuate center line of each of the arcuate slots is located on a single circle; at least two pins are disposed on the rear surface of the yaw angle fine adjustment plate in correspondence with the at least two arcuate slots; and the pins are inserted into the corresponding arcuate slots, whereby the yaw angle fine adjustment pate is mounted on the stage. It is preferred that four of the arcuate slots be formed in the stage at intervals in the circumferential direction of the single circle; and four of the pins are disposed on the rear surface of the yaw angle fine adjustment plate in correspondence with the four arcuate slots. Desirably, the input member for yaw angle fine adjustment is mounted rotatably on the stage; and the transmission means for yaw angle fine adjustment includes a reduction gear train. It is advantageous for the yaw angle fine adjustment plate drive mechanism to include an indicator for indicating the rotation amount of the input means for yaw angle fine adjustment. Preferably, the medical supporting fixing device further comprises: a tilt angle fine adjustment plate interposed between the stage and the supporting fixing means and mounted so as to be pivotable over a predetermined angular range about a pivot center axis extending above the stage in the width direction of the stage; and a tilt angle fine adjustment plate drive mechanism including an input member for tilt angle fine adjustment mounted movably, and transmission means for tilt angle fine adjustment interposed between the input member for tilt angle fine adjustment and the tilt angle fine adjustment plate,

wherein when the input member for tilt angle fine adjustment is moved, the movement of the input member for tilt angle fine adjustment is transmitted to the tilt angle fine adjustment plate via the transmission means for tilt angle fine adjustment, whereby the tilt angle fine adjustment plate is pivoted about the pivot center axis. Preferably, at least two guide members are fixed onto the upper surface of the yaw angle fine adjustment plate; two guided members are fixed onto the rear surface of the tilt angle fine adjustment plate in correspondence with the two guide members; the upper surface of the guide member is a concave arcuate surface, while the lower surface of the guided member is a convex arcuate surface, and the concave arcuate surface and the convex arcuate surface are located on a single cylindrical surface; the convex arcuate surface of the guided member is brought into engagement with the concave arcuate surface of the guide member, whereby the tilt angle fine adjustment plate is mounted on the yaw angle fine adjustment plate; and the supporting fixing means is mounted on the tilt angle fine adjustment plate. Desirably, the input means for tilt angle fine adjustment is mounted rotatably on the yaw angle fine adjustment plate; and the transmission means for tilt angle fine adjustment includes a plurality of reduction gears. It is advantageous for the tilt angle fine adjustment plate drive mechanism to include an indicator for indicating the rotation amount of the input means for tilt angle fine adjustment.

According to another aspect of the present invention, there is provided, as a medical supporting fixing device for solving the aforementioned main technical challenge, a medical supporting fixing device comprising:

a stage;

supporting fixing means for supporting and fixing a predetermined part of a human body;

a tilt angle fine adjustment plate interposed between the stage and the supporting fixing means and mounted so as to be rotatable over a predetermined angular range about a rotation center axis extending above the stage in the width direction of the stage; and

a tilt angle fine adjustment plate drive mechanism including an input member for tilt angle fine adjustment mounted movably, and transmission means for tilt angle fine adjustment interposed between the input member for tilt angle fine adjustment and the tilt angle fine adjustment plate,

wherein when the input member for tilt angle fine adjustment is moved, the movement of the input member for tilt angle fine adjustment is transmitted to the tilt angle fine adjustment plate via the transmission means for tilt angle fine adjustment, whereby the tilt angle fine adjustment plate is rotated about the rotation center axis.

Preferably, at least two guide members are fixed onto the upper surface of the stage; two guided members are fixed onto the rear surface of the tilt angle fine adjustment plate in correspondence with the two guide members; the upper surface of the guide member is a concave arcuate surface, while the lower surface of the guided member is a convex arcuate surface, and the concave arcuate surface and the convex arcuate surface are located on a single cylindrical surface; and the convex arcuate surface of the guided member is brought into engagement with the concave arcuate surface of the guide member, whereby the tilt angle fine adjustment plate is mounted on the stage. Desirably, the input means for tilt angle fine adjustment is mounted rotatably on the stage, and the transmission means for tilt angle fine adjustment includes a reduction gear train. It is advantageous for the tilt angle fine adjustment plate drive mechanism to include an indicator for indicating the rotation amount of the input means for tilt angle fine adjustment. Preferably, the medical supporting fixing device further comprises a yaw angle fine adjustment plate mounted so as to be pivotable over a predetermined angular range about a pivot center axis extending perpendicularly to the tilt angle fine adjustment plate; and a yaw angle fine adjustment plate drive mechanism including an input member for yaw angle fine adjustment disposed movably, and transmission means for yaw angle fine adjustment interposed between the input member for yaw angle fine adjustment and the yaw angle fine adjustment plate; at least two arcuate slots are formed in the tilt angle fine adjustment plate; the arcuate center line of each of the arcuate slots is located on a single circle; at least two pins are disposed on the rear surface of the yaw angle fine adjustment plate in correspondence with the at least two arcuate slots; and the pins are inserted into the corresponding arcuate slots, whereby the yaw angle fine adjustment plate is mounted on the stage; the supporting fixing means is mounted on the yaw angle fine adjustment plate; and when the input member for yaw angle fine adjustment is moved, the movement of the input member for yaw angle fine adjustment is transmitted to the yaw angle fine adjustment plate via the transmission means for yaw angle fine adjustment, whereby the yaw angle fine adjustment plate is pivoted about the pivot center axis. It is preferred that four of the arcuate slots be formed in the tilt angle fine adjustment plate at intervals in the circumferential direction of the single circle; and four of the pins be disposed on the rear surface of the yaw angle fine adjustment plate in correspondence with the four arcuate slots. Desirably, the input member for yaw angle fine adjustment is mounted rotatably on the tilt angle fine adjustment plate; and the transmission means for yaw angle fine adjustment includes a reduction gear train. It is advantageous for the yaw angle fine adjustment plate drive mechanism to include an indicator for indicating the rotation amount of the input means for yaw angle fine adjustment.

### Effects of the Invention

According to the medical supporting fixing device of the present invention, when the input member is moved manually or by a suitable electrically operated means, this movement is transmitted via the transmission means to finely rotate the yaw angle fine adjustment plate or the tilt angle fine adjustment plate, whereby the yaw angle or the tilt angle of the supporting fixing means is finely adjusted.

### BRIEF DESCRIPTION OF THE DRAWINGS

FIG. 1 is a perspective view showing a preferred embodiment of a medical supporting fixing device configured in accordance with the present invention.

FIG. 2 is an exploded perspective view showing a stage, a yaw angle fine adjustment plate, and a tilt angle fine adjustment plate in the medical supporting fixing device shown in FIG. 1.

FIG. 3 is a plan view showing the stage in the medical supporting fixing device shown in FIG. 1.

FIG. 4 is a perspective view of the yaw angle fine adjustment plate in the medical supporting fixing device shown in FIG. 1, as viewed from the back side thereof.

FIG. 5 is a partial perspective view showing an input member for yaw angle fine adjustment and a transmission means for yaw angle fine adjustment in the medical supporting fixing device shown in FIG. 1.

FIG. 6 is a perspective view of the tilt angle fine adjustment plate in the medical supporting fixing device shown in FIG. 1, as viewed from the back side thereof.

FIG. 7 is a side view showing the combination relationship between the yaw angle fine adjustment plate and the tilt angle fine adjustment plate in the medical supporting fixing device shown in FIG. 1.

FIG. 8 is a partial perspective view showing an input member for tilt angle fine adjustment and a transmission means for tilt angle fine adjustment in the medical supporting fixing device shown in FIG. 1.

### MODE FOR CARRYING OUT FOR THE INVENTION

The present invention will now be described in further detail by reference to the accompanying drawings illustrating the preferred embodiment of the medical supporting fixing device configured in accordance with the present invention.

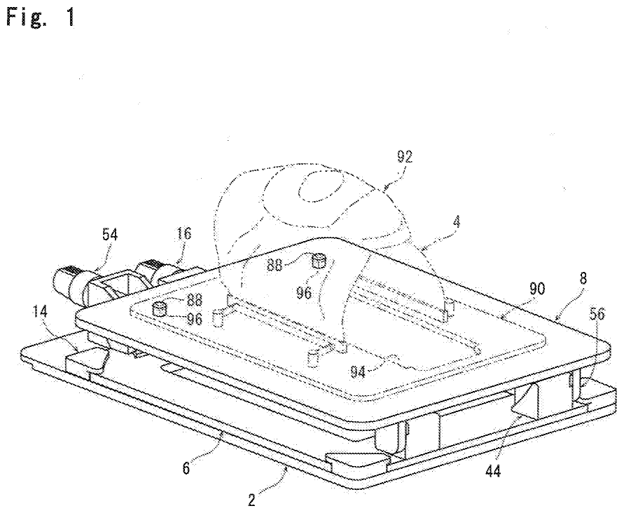

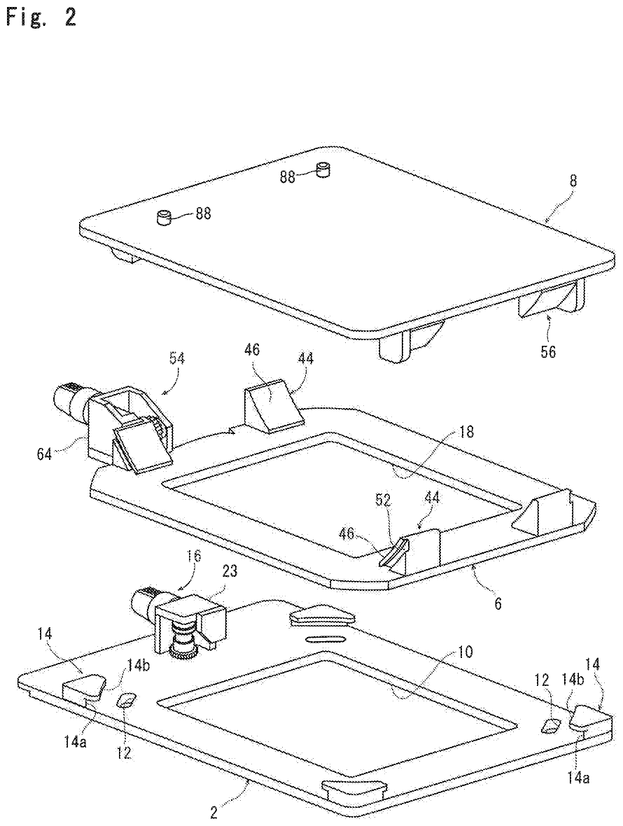

With reference to FIGS. 1 and 2, the illustrated medical supporting fixing device, which has been configured in accordance with the present invention, comprises a stage 2 and a supporting fixing means 4 for supporting and fixing the head of a human body and, along therewith, a yaw angle fine adjustment plate 6 and a tilt angle fine adjustment plate 8 interposed between the stage 2 and the supporting fixing means 4.

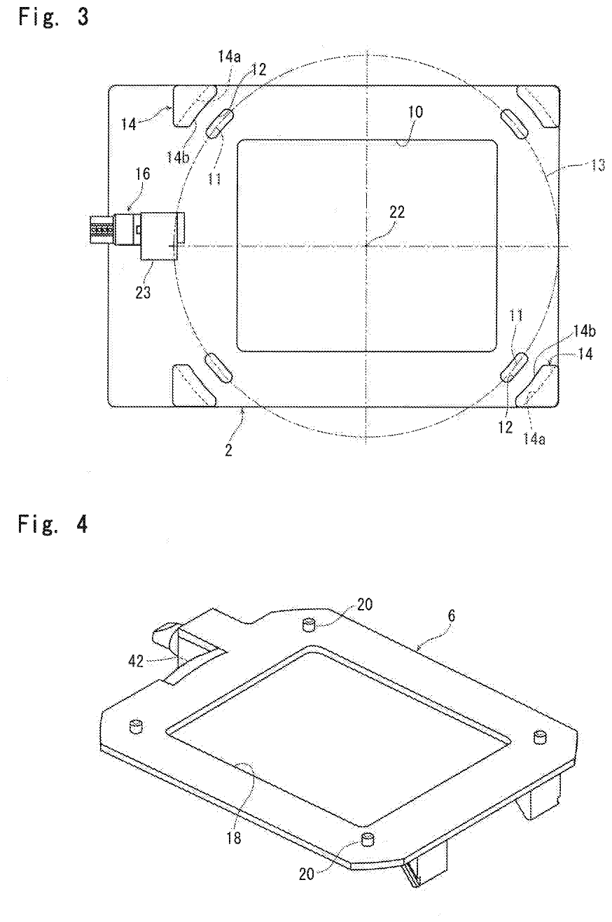

Further referring to FIG. 3 together with FIGS. 1 and 2, the stage 2 is in the shape of a rectangular plate as a whole, and has a rectangular opening 10 formed in its center. The stage 2 is advantageously formed from a material which has, sufficient strength, but has a relatively low specific gravity, and allows radiation to pass therethrough. For example, the stage 2 can be formed from a composite material having a resin foam, such as an acrylic resin foam, surrounded with a carbon fiber-reinforced resin. As will be clearly understood by reference to FIG. 3, four arcuate slots 12 are formed at suitable intervals in the stage 2. Arcuate center lines 11 of these arcuate holes 12 are located on a common imaginary single circle 13. If desired, 2 or 3 of the arcuate slots or 5 or more of the arcuate slots can be formed instead of the four arcuate slots 12. Onto the upper surface of the stage 2, four restraint members 14 are further fixed by suitable fastening means (not shown), such as fastening screws, in such a manner as to be adjacent to and exteriorly of the arcuate slots 12. Each of the restraint members 14 has a base portion 14a having an arcuate inner peripheral surface concentric with the single circle 13, and a restraint portion 14b protruding from the upper end of the base portion 14a toward the arcuate slot 12. In a left-hand part of the upper surface of the stage 2 in FIG. 3, a yaw angle fine adjustment plate drive mechanism is disposed which is indicated in its entirety by a numeral 16. The yaw angle fine adjustment plate drive mechanism 16 will be described later in further detail.

Referring to FIG. 4 along with FIGS. 1 and 2, the yaw angle fine adjustment plate 6 is also in a rectangular shape as a whole, and has a rectangular opening 18 formed in its center. The yaw angle fine adjustment plate 6, like the stage 2, is advantageously formed from a material which has sufficient strength, but has a relatively low specific gravity, and allows radiation to pass therethrough. For example, the yaw angle fine adjustment plate 6 can be formed from a composite material having a foamed resin, such as an acrylic resin foam, surrounded with a carbon fiber-reinforced resin. The yaw angle fine adjustment plate 6 is somewhat smaller than the stage 2, and its four corners are set to be arcuate. The opening 18 formed in the yaw angle fine adjustment plate 6 is advantageously substantially the same in size as the opening 10 formed in the stage 2. As will be clearly illustrated in FIG. 4, pins 20 are fixed to the rear surface of the yaw angle fine adjustment plate 6 by suitable fastening means (not shown), such as fastening screws, in correspondence with the arcuate slots 12 formed in the stage 2. In the illustrated embodiment, 4 of the pins 20 are fixed in correspondence with the four arcuate slots 12. The yaw angle fine adjustment plate 6 in this configuration is superposed on the stage 2 by inserting the four pins 20 arranged in a four-cornered region of its rear surface into the four arcuate slots 12 formed in the stage 2. The diameter of the pin 20 is substantially the same as the width of the arcuate slot 12. Hence, the yaw angle fine adjustment plate 6 is mounted on the stage 2 so as to be pivotable over an angular range, where the pin 20 can move along the arcuate slot 12, about a pivot center axis 22 extending substantially perpendicularly to the stage 2 (i,e., extending perpendicularly to the sheet face in FIG. 3) past the center of the aforementioned single circle 13. The four corners of the yaw angle fine adjustment plate 6 are inserted below the restraint portions 14b of the restraint members 14 disposed on the upper surface of the stage 2, whereby the yaw angle fine adjustment plate 6 is prevented from separating upwardly with respect to the stage 2. Since the pivotal movement of the yaw angle fine adjustment plate 6 with respect to the stage 2 is regulated sufficiently precisely by collaboration between the arcuate slot 12 and the pin 20, some clearance may be present between the side surface of each of the four corners of the yaw angle fine adjustment plate 6 and the inner peripheral surface of the base portion 14a of the restraint member 14. In a state where the yaw angle fine adjustment plate 6 and the stage 2 are in alignment without pivoting of the yaw angle fine adjustment plate 6 with respect to the stage 2, the opening 18 formed in the yaw angle fine adjustment plate 6 is aligned with the opening 10 formed in the stage 2.

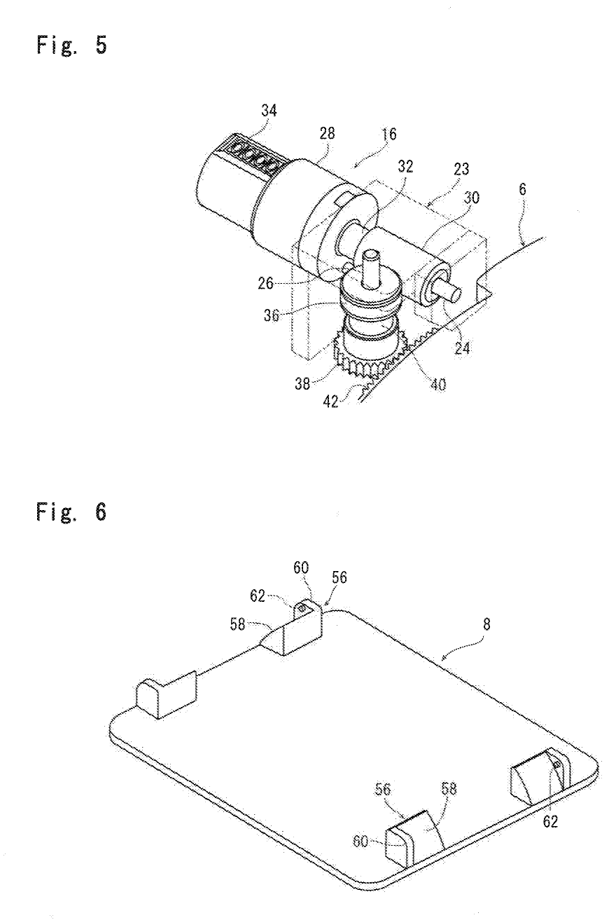

The yaw angle fine adjustment plate drive mechanism 16 disposed on the stage 2 is designed to pivot the yaw angle fine adjustment plate 6 about the pivot center axis 22 with respect to the stage 2 in order to adjust the yaw angle finely. With further reference to FIG. 5 along with FIGS. 1 and 2, a support frame body 23 is fixed onto the upper surface of the stage 2 by a suitable means (not shown) such as an adhesive or a fastening screw. To the in support frame body 23 are fixed a shaft member 24 extending parallel to the stage 2, and a shaft member 26 extending perpendicularly to the stage 2. A cylindrical input member 28 and a worm gear 30 (in FIG. 5, the worm teeth of the worm gear 30 are not illustrated for simplification of the drawing) are mounted rotatably on the shaft member 24. The input member 28 constituting an input member for yaw angle fine adjustment, and the worm gear 30 are coupled together by a connection member 32 in the shape of a small-diameter cylinder, so that the input member 28 and the worm gear 30 rotate integrally. To the shaft member 24, a mechanical indicator 34 is further fixed. The input member 28 is drivingly coupled to an indication mechanism of the indicator 34 and, when the input member 28 is rotated through one turn, the figure indicated on the indicator 34 is increased by one (the constitution of the indicator 34 per se and the driving coupling per se between the input member 28 and the indication mechanism of the indicator 34 may be those well known to people skilled in the art, and thus detailed descriptions thereof are omitted herein). On the shaft member 26 are rotatably mounted a worm wheel 36 (the worm of the worm wheel 36 is not shown in FIG. 5 for simplifying the drawing) engaging the worm gear 30, and a spur gear 38. The worm wheel 36 and the spur gear 38 are coupled together by a connection, member 40 in the shape of a small-diameter cylinder, so that the worm wheel 36 and the spur gear 38 rotate integrally. Onto the rear surface of the yaw angle fine adjustment plate 6, on the other hand, an arcuate spur gear 42 is fixed by a suitable fastening means (not show) such as a fastening screw. This spur gear 42 is engaged with the spur gear 38. When the input member 28 is rotated manually, therefore, this rotation of the input member 28 is transmitted to the yaw angle fine adjustment plate 6 via the worm gear 30, the worm wheel 36, the spur gear 38, and the spur gear 42 to pivot the yaw angle fine adjustment plate 6. The reduction gear ratio by a reduction gear train constituting the transmission means for yaw angle fine adjustment between the input member 28 and the yaw angle fine adjustment plate 6, namely, the worm gear 30, the worm wheel 36, the spur gear 38, and the spur gear 42, can be set, for example, at 360:1. By so doing, the manual rotation of the input member 28 through one turn results in the pivoting of the yaw angle fine adjustment plate 6 through one degree, whereby the yaw angle is changed by one degree.

In the illustrated embodiment, the input member 28 is pivoted manually, but if desired, the input member 28 can be pivoted by a suitable drive source such as an electric motor. Instead of the mechanical indicator 34, moreover, an indicator in another suitable form, such as a liquid crystal indicator, can be used.

Referring again to FIGS. 1 and 2, a guide member 44 is fixed to each of the four corners of the upper surface of the yaw angle fine adjustment plate 6 by a suitable fastening means (not shown) such as a fastening screw. As will be clearly understandable by reference to FIG. 7, a concave arcuate surface 46 is formed on the upper surface of each of the four guide members 44, and these concave arcuate surfaces 46 are located on an imaginary single cylindrical surface 50 centered about a pivot center axis 48 extending above the stage 2 in the width direction of the stage 2 (extending perpendicularly to the sheet face in FIG. 7). An arcuate guide groove 52 extending arcuately in a manner concentric with the concave arcuate surface 46 is formed in a widthwise outer surface of each of the guide members 44. In the illustrated embodiment, the four guide members 44 are disposed on the upper surface of the yaw angle fine adjustment plate 6, but if desired, 2 or 3 or 5 or more of the guide members 44 suitably arranged can be disposed on the upper surface of the yaw angle fine adjustment plate 6. A tilt angle fine adjustment plate drive mechanism indicated entirely at 54 is disposed at one end of the upper surface of the yaw angle fine adjustment plate 6. The tilt angle fine adjustment plate drive mechanism 54 will be described later in further detail.

Referring to FIGS. 6 and 7 along with FIGS. 1 and 2, the tilt angle fine adjustment plate 8 is also in a rectangular shape as a whole. No opening is formed in the tilt angle fine adjustment plate 8. The tilt angle fine adjustment plate 8, like the stage 2 and the yaw angle fine adjustment plate 6, is advantageously formed from a material which has sufficient strength, but has a relatively low specific gravity, and allows radiation to pass therethrough. For example, the tilt angle fine adjustment plate 8 can be formed from a composite material having a foamed resin, such as an acrylic resin foam, surrounded with a carbon fiber-reinforced resin. As will be clearly shown in FIG. 6, guided members 56 are fixed to the four corners of the rear surface of the tilt angle fine adjustment plate 8 by suitable fastening means (not shown), such as fastening screws, in correspondence with the four guide members 44 disposed on the upper surface of the yaw angle fine adjustment plate 6. A convex arcuate surface 58 is formed on the lower surface of each of the guided members 56. These convex arcuate surfaces 58 are located on the aforementioned single cylindrical surface 50. On the widthwise outer side of each of the guided members 56, a rectangular suspending wall, portion 60 is integrally formed. A guided pin 62 protruding widthwise inwardly is fixed to the widthwise inner surface of the suspending wall 60. The tilt angle fine adjustment plate 8 in this configuration has the convex arcuate surfaces 58 of the guided members 56 brought into contact with the concave arcuate surfaces 46 of the guide members 44 disposed on the upper surface of the yaw angle fine adjustment plate 6, so that the tilt angle fine adjustment plate 8 is superposed on the yaw angle fine adjustment plate 6, as illustrated in FIG. 7. The guided pins 62 disposed the guided members 56 are engaged with the arcuate guide grooves 52 formed in the guide members 44. It is advantageous that the diameter of the guided pin 62 be substantially the same as the width of the arcuate guide groove 52. Thus, the tilt angle fine adjustment plate 8 is mounted on the yaw angle fine adjustment plate 6 so as to be pivotable about the aforementioned pivot center axis 48.

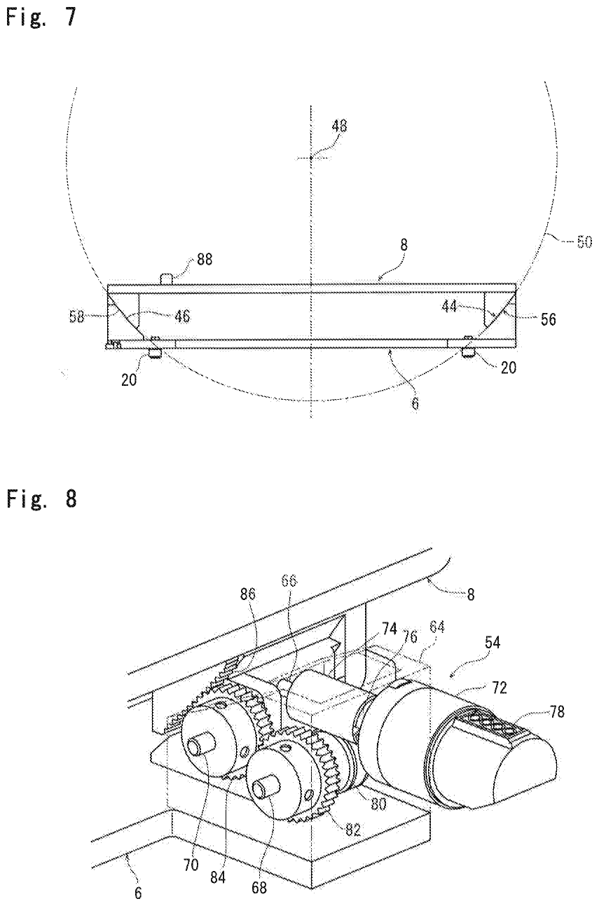

The tilt angle fine adjustment plate drive mechanism 54 disposed on the yaw angle fine adjustment plate 6 is designed to pivot the tilt angle fine adjustment plate 8 about the pivot center axis 48 with respect to the yaw angle fine adjustment plate 6 in order to adjust the tilt angle finely. With further reference to FIG. 8 along with FIGS. 1 and 2, a support frame body 64 is fixed onto the yaw angle fine adjustment plate 6 by a suitable means (not shown) such as an adhesive or a fastening screw. To the support frame body 64 are mixed a shaft member 66 extending in the longitudinal direction of the yaw angle fine adjustment plate 6, and two shaft members 68 and 70 extending in the width direction of the yaw angle fine adjustment plate 6. A cylindrical input member 72 and a worm gear 74 (in FIG. 8, the worm teeth of the worm gear 74 are not illustrated for simplification of the drawing) are mounted rotatably on the shaft member 66. The input member 72 constituting an input member for tilt angle fine adjustment and the worm gear 74 are coupled together by a connection member 76 in the shape of a small-diameter cylinder, so that the input member 72 and the worm gear 74 rotate integrally. To the shaft member 66, a mechanical indicator 78 is further fixed. The input member 72 is drivingly coupled to an indication mechanism of the indicator 78 and, when the input member 72 is rotated through one turn, the figure indicated on the indicator 78 is increased by one (the constitution of the indicator 78 per se and the driving coupling per se between the input member 72 and the indication mechanism of the indicator 78 may be those well known to people skilled in the art, and thus detailed descriptions thereof are omitted herein). On the shaft member 68 are rotatably mounted a worm wheel 80 (in FIG. 8, the worm of the worm wheel 80 is not shown for simplifying the drawing) engaging the worm gear 74, and a spur gear 82. The worm wheel 80 and the spur gear 82 are coupled together by a connection member (not shown) in the shape of a small-diameter cylinder, so that the worm wheel 80 and the spur gear 82 rotate integrally. A spur gear 84 engaging the spur gear 82 is rotatably mounted on the shaft member 70. Onto the lower surface of the tilt angle fine adjustment plate 8, on the other hand, an arcuate spur gear 86 is fixed by a suitable fastening means (not shown) such as a fastening screw. This spur gear 86 is engaged with the spur gear 84. When the input member 72 is rotated manually, therefore, this rotation of the input member 72 is transmitted to the tilt angle fine adjustment plate 8 via the worm gear 74, the worm wheel 80, the spur gear 82, the spur gear 84, and the spur gear 86 to pivot the tilt angle fine adjustment plate 8. The reduction gear ratio by a reduction gear train constituting a transmission means for tilt angle fine adjustment between the input member 72 and the tilt angle fine adjustment plate 8, namely, the worm gear 74, the worm wheel 80, the spur gear 82, the spur gear 84, and the spur gear 86, can be set, for example, at 360:1. By so doing, the manual rotation of the input member 72 through one turn results in the pivoting of the tilt angle fine adjustment plate 8 through one degree, whereby the tilt angle is finely adjusted.

In the tilt angle fine adjustment plate drive mechanism 54 as well, as in the case of the yaw angle fine adjustment plate drive mechanism 16, the input member 72 is pivoted manually, but if desired, the input member 72 can be pivoted by a suitable drive source such as an electric motor. Instead of the mechanical indicator 78, moreover, an indicator in another suitable form, such as a liquid crystal indicator, can be used.

As shown in FIGS. 1 and 2, locking pins 88 serving as a pair are fixed, with widthwise spacing therebetween, in an end part of the upper surface of the tilt angle fine adjustment plate 8 by suitable fastening means (not shown) such as fastening screws. The upper surface of the tilt angle fine adjustment plate 8 is mounted with a supporting fixing means 4 for supporting and fixing a predetermined part of a human body, the head in the illustrated embodiment. The supporting fixing means in the illustrated embodiment includes a base plate 90 in the form of a rectangular plate, and a cover member 92 mounted on the base plate 90. An opening 94 is formed in the center of the base plate 90, and holes 96 serving as a pair are formed, with widthwise spacing therebetween, in an end part of the base plate 90. The supporting fixing means 4 is mounted on the tilt angle fine adjustment plate 8 by fitting the paired locking pins 88 disposed on the upper surface of the tilt angle fine adjustment plate 8 into the paired holes 96 formed in the base plate 90. The supporting fixing means 4 per se does not constitute a novel feature in the supporting fixing device configured in accordance with the present invention, and may be of a form well known to people skilled in the art. Hence, a detailed explanation for the configuration of the supporting fixing means 4 is omitted.

For radiotherapy or diagnostic imaging, the medical supporting fixing device constituted in accordance with the present invention is disposed on a suitable bed on which a human body is lying. (If desired, a part of the bed can be utilized as the stage of the medical supporting fixing, device constituted in accordance with the present invention.) The head of the human body lying on the bed is positioned on the tilt angle fine adjustment plate 8 through the opening formed in the base plate 90 of the supporting fixing means 4. Then, the human head is covered with the cover member 92 for fixing. To adjust the position of the human head precisely, the input member 28 of the yaw angle fine adjustment plate drive mechanism 16 is rotated to pivot the yaw angle fine adjustment plate 6 finely about the pivot center axis 22. By so doing, the tilt angle fine adjustment plate 8 and the supporting fixing means 4 are also finely pivoted in accordance with the pivoting of the yaw angle fine adjustment plate 6, whereby the yaw angle of the human head is finely adjusted. Also, the input member 72 of the tilt angle fine adjustment plate drive mechanism 54 is rotated to pivot the tilt angle fine adjustment plate 8 finely about the pivot center axis 48. By so doing, the supporting fixing means 4 is also finely pivoted in accordance with the pivoting of the tilt angle fine adjustment plate 8, whereby the tilt angle of the human head is finely adjusted.

The preferred embodiment of the medical supporting fixing device constituted in accordance with the present invention has been described in detail above by reference to the accompanying drawings. However, the invention is in no way limited to this embodiment, and there is no need to dwell on the fact that various changes and modifications can be made without departing from the range of the invention.

In the illustrated embodiment, for example, the yaw angle fine adjustment plate 6 is mounted on the stage 2, the tilt angle fine adjustment late 8 is mounted on the yaw angle fine adjustment plate 6, and the supporting fixing means 4 is mounted on the tilt angle fine adjustment plate 8. However, the tilt angle fine adjustment plate 8 can be mounted on the stage 2, the yaw angle fine adjustment plate 6 can be mounted on the tilt angle fine adjustment plate 8, and the supporting fixing means 4 can be mounted on the yaw angle fine adjustment plate 6. In this case, the manner of mounting the tilt angle fine adjustment plate 8 on the yaw angle fine adjustment plate 6 in the illustrated embodiment can be adopted for mounting the tilt angle fine adjustment plate 8 on the stage 2; the manner of mounting the yaw angle fine adjustment plate 6 on the state 2 in the illustrated embodiment, can be adopted for mounting the yaw angle fine adjustment plate 6 on the tilt angle fine adjustment plate 8; and the manner of mounting the supporting fixing means 4 on the tilt angle fine adjustment plate 8 in the illustrated embodiment can be adopted for mounting the supporting fixing means 4 on the yaw angle fine adjustment plate 6. In the illustrated embodiment, moreover, the tilt angle fine adjustment plate 8 as well as the yaw angle fine adjustment plate 6 is interposed between the stage 2 and the supporting fixing means 4. If desired, however, only one of the yaw angle fine adjustment plate 6 and the tilt angle fine adjustment plate 8 can be interposed between the stage 2 and the supporting fixing means 4.

### EXPLANATIONS OF LETTERS OR NUMERALS

2: Stage

4: Supporting fixing means

6: Yaw angle fine adjustment plate

8: Tilt angle fine adjustment plate

12: Arcuate slot

16: Yaw angle fine adjustment plate drive mechanism

20: Pin

22: Pivot center axis

28: Input member (input member for yaw angle fine adjustment)

30: Worm gear (transmission means for yaw angle fine adjustment)

34: Indicator

36: Worm wheel (transmission means for yaw angle fine adjustment)

38: Spur gear (transmission means for yaw angle fine adjustment)

42: Spur gear (transmission means for yaw angle fine adjustment)

44: Guide member

46: Concave arcuate surface

48: Pivot center axis

54: Tilt angle fine adjustment plate drive mechanism

56; Guided member

58: Convex arcuate surface

72: Input member (input member for tilt angle fine adjustment)

74: Worm gear (transmission means for tilt angle fine adjustment)

78: Indicator

80: Worm wheel (transmission means for tilt angle fine adjustment)

82: Spur gear (transmission means for tilt angle fine adjustment)

84: Spur gear (transmission means for tilt angle fine adjustment)

86: Spur gear (transmission means for tilt angle fine adjustment)

1. A medical supporting fixing device, comprising:
a stage;
supporting fixing means for supporting and fixing a predetermined part of a human body;
a yaw angle fine adjustment plate interposed between the stage and the supporting fixing means and mounted so as to be pivotable over a predetermined angular range about a pivot center axis extending perpendicularly to the stage; and
a yaw angle fine adjustment plate drive mechanism including an input member for yaw angle fine adjustment disposed movably, and transmission means for yaw angle fine adjustment interposed between the input member for yaw angle fine adjustment and the yaw angle fine adjustment plate,
wherein when the input member for yaw angle fine adjustment is moved, movement of the input member for yaw angle fine adjustment is transmitted to the yaw angle fine adjustment plate via the transmission means for yaw angle fine adjustment, whereby the yaw angle fine adjustment plate is pivoted about the pivot center axis.

2. The medical supporting fixing device according to claim 1, wherein
at least two arcuate slots are formed in the stage;
an arcuate center line of each of the arcuate slots is located on a single circle;
at least two pins are disposed on a rear surface of the yaw angle fine adjustment plate in correspondence with the at least two arcuate slots; and
the pins are inserted into the corresponding arcuate slots, whereby the yaw angle fine adjustment plate is mounted on the stage.

3. The medical supporting fixing device according to claim 2, wherein
four of the arcuate slots are formed in the stage at intervals in a circumferential direction of the single circle; and
four of the pins are disposed on the rear surface of the yaw angle fine adjustment plate in correspondence with the four arcuate slots.

4. The medical supporting fixing device according to claim 1, wherein
the input member for yaw angle fine adjustment is mounted rotatably on the stage; and
the transmission means for yaw angle fine adjustment includes a reduction gear train.

5. The medical supporting fixing device according to claim 4, wherein
the yaw angle fine adjustment plate drive mechanism includes an indicator for indicating a rotation amount of the input member for yaw angle fine adjustment.

6. The medical supporting fixing device according to claim 1, further comprising:
a tilt angle fine adjustment plate interposed between the stage and the supporting fixing means and mounted so as to be pivotable over a predetermined angular range about a pivot center axis extending above the stage in a width direction of the stage; and
a tilt angle fine adjustment plate drive mechanism including an input member for tilt angle fine adjustment mounted movably, and transmission means for tilt angle fine adjustment interposed between the input member for tilt angle fine adjustment and the tilt angle fine adjustment plate,
wherein when the input member for tilt angle fine adjustment is moved, movement of the input member for tilt angle fine adjustment is transmitted to the tilt angle fine adjustment plate via the transmission means for tilt angle fine adjustment, whereby the tilt angle fine adjustment plate is pivoted about the pivot center axis.

7. The medical supporting fixing device according to claim 6, wherein
at least two guide members are fixed onto an upper surface of the yaw angle fine adjustment plate;
two guided members are fixed onto a rear surface of the tilt angle fine adjustment plate in correspondence with the two guide members;
an upper surface of the guide member is a concave arcuate surface, while a lower surface of the guided member is a convex arcuate surface, and the concave arcuate surface and the convex arcuate surface are located on a single cylindrical surface;
the convex arcuate surface of the guided member is brought into engagement with the concave arcuate surface of the guide member, whereby the tilt angle fine adjustment plate is mounted on the yaw angle fine adjustment plate; and
the supporting fixing means is mounted on the tilt angle me adjustment plate.

8. The medical supporting fixing device according to claim 7, wherein
the input member for tilt angle fine adjustment is mounted rotatably on the yaw angle fine adjustment plate; and
the transmission means for tilt angle fine adjustment includes a plurality of reduction gears.

9. The medical supporting fixing device according to claim 8, wherein
the tilt angle fine adjustment plate drive mechanism includes an indicator for indicating a rotation amount of the input member for tilt angle fine adjustment.

10. A medical supporting fixing device, comprising:
a stage;
supporting fixing means for supporting and fixing a predetermined part of a human body;
a tilt angle fine adjustment plate interposed between the stage and the supporting fixing means and mounted so as to be rotatable over a predetermined angular range about a rotation center axis extending above the stage in a width direction of the stage; and
a tilt angle fine adjustment plate drive mechanism including an input member for tilt angle fine adjustment mounted movably, and transmission means for tilt angle fine adjustment interposed between the input member for tilt angle fine adjustment and the tilt angle fine adjustment plate,
wherein when the input member for tilt angle fine adjustment is moved, movement of the input member for tilt angle fine adjustment is transmitted to the tilt angle fine adjustment plate via the transmission means for tilt angle fine adjustment, whereby the tilt angle fine adjustment plate is rotated about the rotation center axis.

11. The medical supporting fixing device according to claim 10, wherein
at least two guide members are fixed onto an upper surface of the stage;
two guided members are fixed onto a rear surface of the tilt angle fine adjustment plate in correspondence with the two guide members;
an upper surface of the guide member is a concave arcuate surface, while a lower surface of the guided member is a convex arcuate surface, and the concave arcuate surface and the convex arcuate surface are located on a single cylindrical surface; and
the convex arcuate surface of the guided member is brought into engagement with the concave arcuate surface of the guide member, whereby the tilt angle fine adjustment plate is mounted on the stage.

12. The medical supporting fixing device according to claim 11, wherein
the input member for tilt angle fine adjustment is mounted rotatably on the stage; and
the transmission means for tilt angle fine adjustment includes a reduction gear train.

13. The medical supporting fixing device according to claim 12, wherein
the tilt angle fine adjustment plate drive mechanism includes an indicator for indicating a rotation amount of the input member for tilt angle fine adjustment.

14. The medical supporting fixing device according to claim 10, further comprising:
a yaw angle fine adjustment plate mounted so as to be pivotable over a predetermined angular range about a pivot center axis extending perpendicularly to the tilt angle fine adjustment plate; and
a yaw angle fine adjustment plate drive mechanism including an input member for yaw angle fine adjustment disposed movably, and transmission means for yaw angle fine adjustment interposed between the input member for yaw angle fine adjustment and the yaw angle fine adjustment plate,
wherein at least two arcuate slots are formed in the tilt angle fine adjustment plate;
an arcuate center line of each of the arcuate slots is located on a single circle;
at least two pins are disposed on a rear surface of the yaw angle fine adjustment plate in correspondence with the at least two arcuate slots; and
the pins are inserted into the corresponding arcuate slots, whereby the yaw angle fine adjustment plate is mounted on the tilt angle fine adjustment plate;
the supporting fixing means is mounted on the yaw angle fine adjustment plate; and
when the input member for yaw angle fine adjustment is moved, movement of the input member for yaw angle fine adjustment is transmitted to the yaw angle fine adjustment plate via the transmission means for yaw angle fine adjustment, whereby the yaw angle fine adjustment plate is pivoted about the pivot center axis.

15. The medical supporting fixing device according to claim 14, wherein
four of the arcuate slots are formed in the tilt angle fine adjustment plate at intervals in a circumferential direction of the single circle; and
four of the pins are disposed on the rear surface of the yaw angle fine adjustment plate in correspondence with the four arcuate slots.

16. The medical supporting fixing device according to claim 14, wherein
the input member for yaw angle fine adjustment is mounted rotatably on the tilt angle fine adjustment plate; and
the transmission means for yaw angle fine adjustment includes a reduction gear train.

17. The medical supporting fixing device according to claim 16, wherein
the yaw angle fine adjustment plate drive mechanism includes an indicator for indicating a rotation amount of the input member for yaw angle fine adjustment.
